(19) United States
(12) Patent Application Publication
(10) Pub. No.: US 2024/0127594 A1
(43) Pub. Date: Apr. 18, 2024

(54) METHOD OF MONITORING EXPERIMENTAL ANIMALS USING ARTIFICIAL INTELLIGENCE

(71) Applicants: Shih-Siou Wang, Taichung City (TW); Wen-Ai Wu, Taichung City (TW)

(72) Inventors: Shih-Siou Wang, Taichung City (TW); Wen-Ai Wu, Taichung City (TW)

(73) Assignee: TANGENE INCORPORATED, Taichung City (TW)

(21) Appl. No.: 17/965,868

(22) Filed: Oct. 14, 2022

(51) Int. Cl. G06V 20/52; G06V 40/10; G06V 40/20

(52) U.S. Cl. CPC G06V 20/52; G06V 40/10; G06V 40/20

(57) ABSTRACT

A method of monitoring experimental animals includes the steps of (1) obtaining image data from a self-moved device to form an image data set; (2) converting key frames of the image data of the image data set to still images; (3) performing a GUI program of a computer to label a coordinate of a target object of the still images as a label data and storing the label data in the computer, and labeling the label data as a target data set, (4) inputting data of the target data set into a machine learning platform and establishing an identification model; (5) placing the identification model in at least one control unit; and (6) forming a new target data set by subjecting a new image data to steps (2) and (3), and comparing the new target data set with the identification model to obtain an identification result.

### FIELD OF THE INVENTION

The invention relates to methods for monitoring experimental animals and more particularly to a method of monitoring experimental animals using artificial intelligence.

### BACKGROUND OF THE INVENTION

A typical establishment for housing and feeding experimental animals has the following drawbacks:

Employees do manual labor to take care of experimental animals and the care is sometimes insufficient. An employee may go through the establishment to monitor the experimental animals confined in the cages in the morning and the afternoon every day. The monitoring includes counting the number of the experimental animals, checking whether the experimental animals are hurt or even dead, and checking whether the living environment of the experimental animals is acceptable. However, the method of monitoring experimental animals cage by cage by going through the establishment is time consuming. Further, the possibility of finding any irregularities is low due to the great number of the cages. It is often that the employee cannot find experimental animals in trouble immediately. Hence, the experimental animal right is not well protected especially in case of emergency.

Pollution control and illumination of cages. An employee is required to wear a protective gown prior to entering the establishment because pollution may be generated by experimental animals confined in the cage. Further, a long time monitoring of the confined experimental animals is impossible. Data about the experimental animals is thus insufficient. Another factor to be considered is that lights in the cage are set to turn on for first 12 hours and turn off for second 12 hours alternately per day. With respect to nighttime checking, the employee is required to use special equipment prior to entering the establishment for the sake of preventing the experimental animals from being bothered. This is why it is very difficult of monitoring the experimental animals in night time. Thus, data of experimental animals' behavior in the night is rare.

There is no standard operation procedure (SOP). Different employees may have different monitoring results of the confined experimental animals because the monitoring is done by manual labor. Regarding cage changes, it is typical of changing all dirty cages with clean ones in the same room. However, experimental animals are afraid of being bothered due to nature. Thus, a minimum number of cage changes as well as giving a well living space to the experimental animals are desired.

### SUMMARY OF THE INVENTION

It is therefore one object of the invention to provide a method of monitoring experimental animals, comprising the steps of (S1) obtaining a plurality of image data from a self-moved device to form an image data set wherein the self-moved device includes at least one control unit with edge computing and at least one sensor unit electrically connected to the at least one control unit, and wherein the self-moved device is disposed in a position proximate cages; (S2) converting key frames of the image data of the image data set to still images by performing a motion detection algorithm and a key frames extraction algorithm; (S3) performing a graphic user interface (GUI) program of a computer to label a coordinate of a target object of the still images as a label data and storing the label data in the computer, and utilizing a graph algorithm to quickly label the label data as a target data set to be used by a machine learning platform; (S4) inputting data of the target data set into the machine learning platform and establishing an identification model by performing a machine learning algorithm; (S5) placing the identification model in the at least one control unit; and (S6) obtaining a new image data set from the at least one sensor unit of the self-moved device, comparing the new image data set with the identification model to obtain an identification result including an identified animal and its feeding environment, and sending the identification result to a central management platform served as an information source of monitoring and abnormal notification.

Preferably, the self-moved device further comprises at least one rail unit disposed in proximity to the cages, and at least one drive unit electrically connected to the at least one rail unit and configured to activate the at least one rail unit.

The invention has the following advantages and benefits in comparison with the conventional art: The rail unit can move leftward and rightward (or upward and downward) alternately so that the moveable sensor unit can continuously monitor the experimental animals confined in the cages for a long period of time. Thus, SOP can be followed. Only cage changes are required with bothering to the experimental animals being a minimum. Care is thus optimized. There is no need for an employee to go through the establishment to monitor the experimental animals confined in the cages. Pollution control is enhanced. The possibility of finding any irregularities is greatly increased. As a result, purposes of automatic monitoring and taking good care of experimental animals are obtained.

The above and other objects, features and advantages of the invention will become apparent from the following detailed description taken with the accompanying drawings.

### BRIEF DESCRIPTION OF THE DRAWINGS

FIG. 1 is a flow chart of a method of monitoring experimental animals using artificial intelligence according to the invention;

FIG. 2 schematically depicts an object recognition module of the invention;

FIG. 3 schematically depicts an image segmentation module of the invention;

FIG. 4 schematically depicts an animal instance recognition module of the invention:

FIG. 5 schematically depicts an animal behavioral recognition module of the invention; and

FIG. 6 is a perspective view of an apparatus for monitoring experimental animals according to the invention, the apparatus being configured to carry out the method.

### DETAILED DESCRIPTION OF THE INVENTION

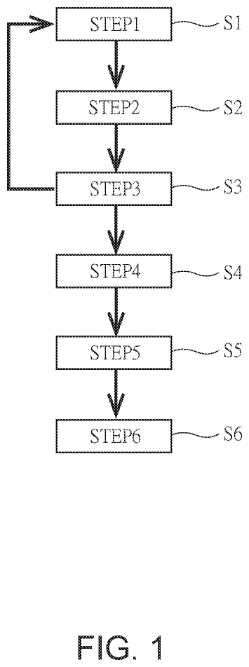

Referring to FIGS. 1 to 6, a method of monitoring experimental animals using artificial intelligence in accordance with the invention is illustrated and comprises the step of:

(S1) obtaining a plurality of image data from a self-moved device to form an image data set.

The self-moved device is disposed in a rack 200 including a plurality of cages 210 each for confining an experimental animal. The image data is a still image or a dynamic video. The self-moved device is a linear rail assembly, a self-moved vehicle or an unmanned aerial vehicle (UAV). In the embodiment of the invention, the self-moved device is the linear rail assembly and includes a plurality of rail units 10, a plurality of drive units 20, a plurality of control units 40 and a plurality of sensor units 50. The rail units 10 are provided in front of the cages 210. The drive units 20 are electrically connected to the rail units 10 and are configured to activate the rail units 10. Each control unit 40 includes a controller (not shown) such as an edge computing controller including a central processing unit (CPU), a memory, a graphics processing unit (GPU), a peripheral input/output (I/O) interface, a wireless transmission unit, a data storage unit and a power supply unit. The sensor units 50 are electrically connected to the control units 40. Each sensor unit 50 includes a sensor (not shown) such as a camera, an infrared monitor, a thermometer, a hygrometer, a microphone, a vibration meter, a pressure gauge, or any combination thereof. The image data set includes kinds of experimental animal including features such as ages and colors of different animals; conditions of living environments including inclined cage, low food storage, and wet pad due to feces and leakage; and animal behaviors including food, climbing, fighting, mating, and unusual behaviors.

The method further comprises the step of (S2) converting key frames of the image data of the image data set to still images by performing a motion detection algorithm and a key frames extraction algorithm. Further, normalization is performed on images generated by different types of camera modules by performing a computer vision algorithm. Thus, data consistence is achieved and in turn, it increases training speed and accuracy of a machine learning platform.

The method further comprises the step of (S3) performing a graphic user interface (GUI) program of a computer to label a coordinate of a target object of the still images as a label data and storing the label data in the computer.

In the embodiment of the invention, the target object is an experimental animal and an object in the environment to be labeled. The computer is a desktop computer or a laptop. Further, an employee in charge of labeling image may utilize a graph algorithm to quickly label the label data as a target data set which is to be used by the machine learning platform for training. The target data set which the machine learning models trained with can be obtained by using the optional modules, wherein the optional modules include an object recognition module, an image segmentation module, an animal instance recognition module, or an animal behavioral recognition module so that a user may select a desired module to be used based on different target objects or different monitoring purposes.

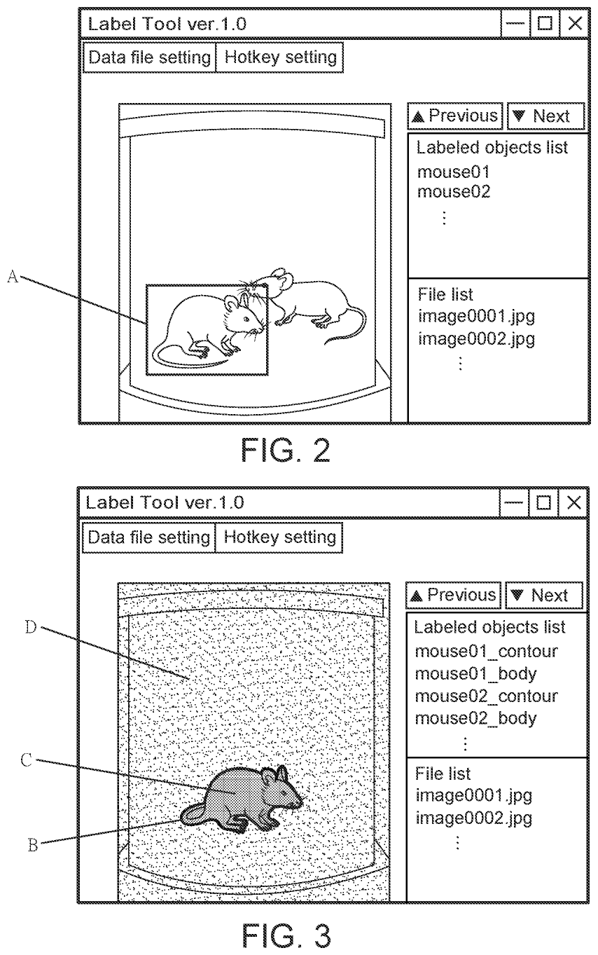

As shown in FIG. 2 specifically, the object recognition module is performed by the GUI program which labels position of each label data in a bounding box A and stores the labeled data in the object recognition module.

As shown in FIG. 3 specifically, the image segmentation module is performed by the GUI program which labels image pixels of each label data in an object contour B, an object C, and a background D, and stores the labeled data in the image segmentation module.

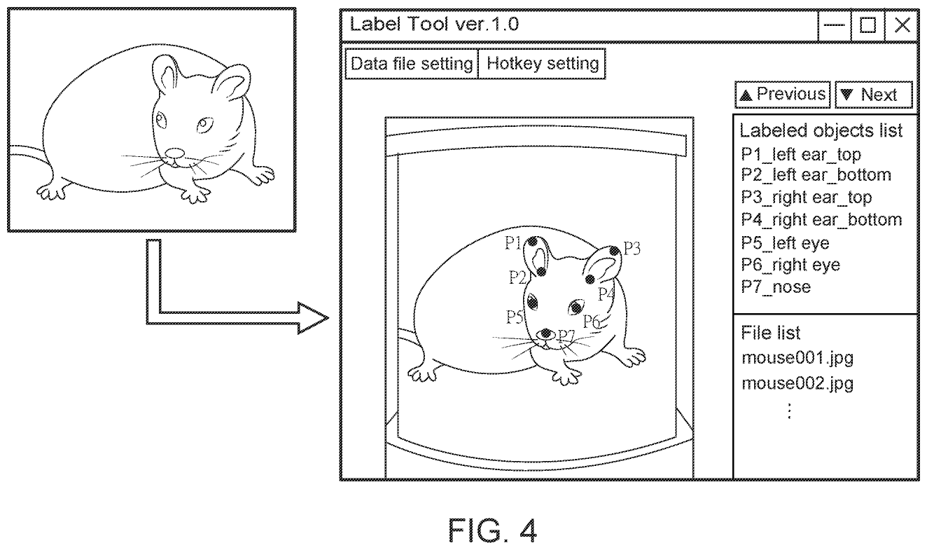

As shown in FIG. 4 specifically, the animal instance recognition module is performed by the GUI program which labels areas of facial landmarks P1 to P7 of an object image in each label data and stores the labeled data in the animal instance recognition module.

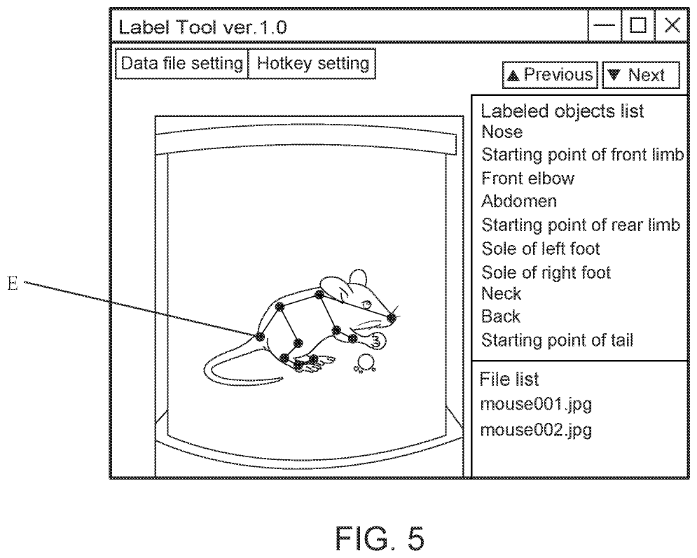

As shown in FIG. 5 specifically, the animal behavioral recognition module is performed by the GUI program which labels object decision points of an object image in each label data as E and stores the labeled data in the animal behavioral recognition module.

The method further comprises the step of (S4) inputting data of the target data set into the machine learning platform and establishing an identification model by performing a machine learning algorithm.

The method further comprises the step of (S5) placing the identification model in the control units 40.

The method further comprises the step of (S6) obtaining a new image data set from the sensor units 50 of the self-moved device, comparing the new image data set with the identification model to obtain an identification result including an identified animal and its feeding environment, and sending the identification result to a central management platform.

The central management platform is a near computer or a cloud virtual host and serves as an information source of monitoring and abnormal notification.

The step (S6) further comprises the sub-step of sending abnormal portions of the identification result to an administrator for review in order to decide whether relabeling is necessary to generate a new target data set by step 3. The new target data set is further sent to the machine learning platform for training the identification model again. This can increase accuracy of the identification model.

In the step (S4), based on different applications, the machine learning algorithm may cover from rule-based algorithms including clustering, support vector machine (SVM), and to learning-based algorithms including a deep learning algorithm having a neural network as core.

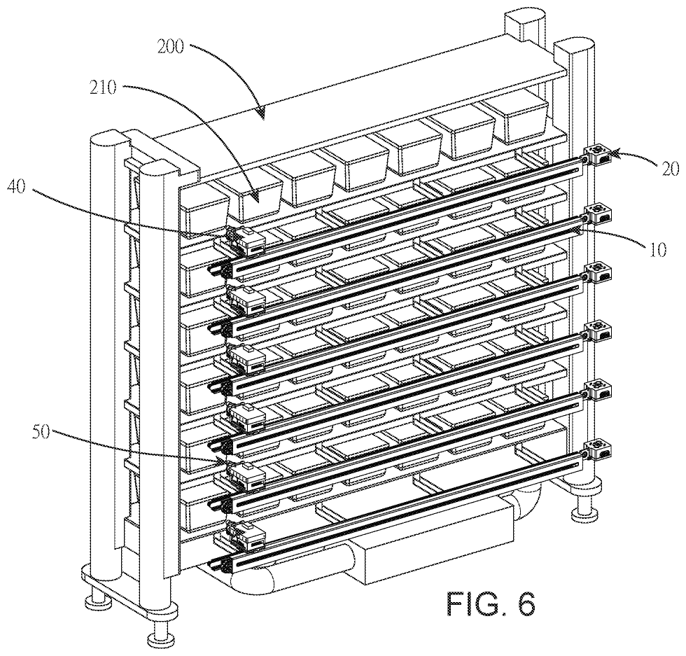

As shown in FIG. 6 specifically, the drive units 20 may activate the rail units 10 which in turn move the control units 40 leftward and rightward alternately along the rail units 10. Thus, the sensor units 50 may continuously monitor an experimental animal confined in the cage 210 for a long time.

While the invention has been described in terms of preferred embodiments, those skilled in the art will recognize that the invention can be practiced with modifications within the spirit and scope of the appended claims.

What is claimed is:

1. A method of monitoring experimental animals, the method comprising the steps of:
(S1) obtaining a plurality of image data from a self-moved device to form an image data set wherein the self-moved device includes at least one control unit with edge computing and at least one sensor unit electrically connected to the at least one control unit, and wherein the self-moved device is disposed in a position proximate cages;
(S2) converting key frames of the image data of the image data set to still images by performing a motion detection algorithm and a key frames extraction algorithm;
(S3) performing a graphic user interface (GUI) program of a computer to label a coordinate of a target object of the still images as a label data and storing the label data in the computer, and utilizing a graph algorithm to quickly label the label data as a target data set to be used by a machine learning platform;
(S4) inputting data of the target data set into the machine learning platform and establishing an identification model by performing a machine learning algorithm;
(S5) placing the identification model in the at least one control unit; and
(S6) obtaining a new image data set from the at least one sensor unit of the self-moved device, comparing the new image data set with the identification model to obtain an identification result including an identified animal and its feeding environment, and sending the identification result to a central management platform served as an information source of monitoring and abnormal notification.

2. The method of claim 1, wherein the self-moved device is a linear rail assembly, a self-moved vehicle, or an unmanned aerial vehicle (UAV); the at least one control unit is an edge computing controller including a central processing unit (CPU), a memory, a graphics processing unit (GPU), a peripheral input/output (I/O) interface, a wireless transmission unit, a data storage unit, and a power supply unit; and the at least one sensor unit is a camera, an infrared monitor, a thermometer, a hygrometer, a microphone, a vibration meter, a pressure gauge, or any combination thereof.

3. The method of claim 1, wherein the image data set includes kinds of experimental animal, conditions of living environments, and animal behaviors; and wherein normalization is performed on the image data set by performing a computer vision algorithm.

4. The method of claim 1, wherein the target data set which the machine learning models trained with can be obtained by using the optional modules, and wherein the optional modules include an object recognition module, an image segmentation module, an animal instance recognition module, or an animal behavioral recognition module.

5. The method of claim 4, wherein:
the object recognition module is performed by the GUI program which labels position of each label data in a bounding box and stores the labeled data in the object recognition module;
the image segmentation module is performed by the GUI program which labels image pixels of each label data in an object contour, an object, and a background, and stores the labeled data in the image segmentation module;
the animal instance recognition module is performed by the GUI program which labels areas of a plurality of facial landmarks of an object image in each label data and stores the labeled data in the animal instance recognition module; and
the animal behavioral recognition module is performed by the GUI program which labels object decision points of an object image in each label data and stores the labeled data in the animal behavioral recognition module.

6. The method of claim 1, wherein step (S6) comprises sending abnormal portions of the identification result to an administrator for review in order to decide whether relabeling is necessary to generate a new target data set by step 3, wherein the new target data set is further sent to the machine learning platform for training the identification model again, thereby increasing accuracy of the identification model.

7. The method of claim 1, wherein the self-moved device further comprises at least one rail unit disposed in proximity to the cages, and at least one drive unit electrically connected to the at least one rail unit and configured to activate the at least one rail unit.

8. The method of claim 1, wherein the central management platform is a near computer or a cloud virtual host.
